(19) United States
(12) Patent Application Publication
(10) Pub. No.: US 2025/0072641 A1
(43) Pub. Date: Mar. 6, 2025

(54) FOAM MAT AND METHOD FOR MANUFACTURING A FOAM MAT

(71) Applicant: ALADDIN MANUFACTURING CORPORATION, Calhoun, GA (US)

(72) Inventor: Chunming LIU, Calhoun, GA (US)

(21) Appl. No.: 18/950,768

(22) Filed: Nov. 18, 2024

Related U.S. Application Data
(63) Continuation-in-part of application No. PCT/IB2023/054856, filed on May 11, 2023.
(60) Provisional application No. 63/343,291, filed on May 18, 2022.

(51) Int. Cl. A47G 27/02; B29C 43/00; B29C 43/02; B29C 43/18; B29K 105/00; B29K 105/04; B29K 105/26; B29L 31/00

(52) U.S. Cl. CPC A47G 27/0212; A47G 27/0281; B29C 43/003; B29C 43/021; B29C 2043/023; B29C 2043/185; B29K 2105/045; B29K 2105/251; B29K 2105/26; B29K 2995/0063; B29L 2031/7324

(57) ABSTRACT

Foam edge waste may be shredded or ground into foam particles rather than discarding them. The particles may be mixed with an adhesive and subject to high temperature and high pressure to form into new foam bodies with configurable densities. Utilizing discarded foam sections this way reduces the waste of foam, reduces environmental pollution caused by foam waste combustion, offers more environmental protection and saves resources. The resulting foam articles have reduced water retention and provide superior comfort by making a foam with consistent properties from inconsistent materials.

The present invention relates to a foam mat and method for manufacturing a foam mat.

### CROSS REFERENCE TO RELATED APPLICATIONS

This application is a continuation-in-part of PCT/IB2023/054856, filed May 11, 2023, which claims the benefit of U.S. Provisional Patent Application Ser. No. 63/343,291, filed May 18, 2022, each of which is hereby incorporated by reference in its entirety.

### BACKGROUND

In many cases, sheets of virgin foam are used to make cushioned products. The edges of the sheet may be trimmed away to create a size and shape for a product from the center of the sheet so that it has sharp edges. The trimmed edges are discarded or recycled to produce rebonded foam such as is typically used for carpet padding. However, these sheets of virgin foam typically have a consistent and specific density that may not be useful in making carpet padding or cushions for mats.

Simultaneously, foam mats, as are typically used in kitchens, bathrooms, and workstations, have been made from virgin foam of a density desirable for each specific type of mat. Heretofore, the inconsistent nature of the rebond has not provided an acceptable feel and desired comfort for those mats so has not been used.

Additionally, closed-cell foam has not been a desired product to use in mats that are expected to be washable. Closed-cell foam, frequently called “memory foam” does not dry as quickly as open-cell foam. Purchasers and users of mats expect that foam mats may be washed in a household washing machine and may be dried in a household dryer in an expected time. However, closed-cell foam takes considerably longer to dry in a household dryer, which may not be desired.

### BRIEF SUMMARY

To this aim, the invention relates to a foam mat and a method as defined in the appended independent claims, wherein preferred embodiments are defined in the dependent claims.

In a first independent aspect, the invention relates to a mat comprising: a cushion layer comprising a thickness, a top side, a bottom side, and wherein the top side is bonded to a fabric layer; the cushion layer comprising a foam sheet having a first density; and wherein the foam sheet is comprised of a plurality of foam particles having a first range of sizes and a first range of densities.

In a second independent aspect, the invention relates to a mat comprising: a cushion layer comprising a thickness, a top side, a bottom side, and wherein the top side is bonded to a fabric layer; wherein the cushion layer has a first density and comprises a first plurality of foam particles of a second density bonded together; and wherein the first density is greater than the second density.

In a third independent aspect, the invention relates to the method of forming a mat comprises: milling at least one segment of foam having a first density to form a plurality of foam particles, wherein the particles of foam have sizes in a first size range of between 1 mm and 15 mms; mixing the plurality of particles with glue; applying heat and compression to the plurality of foam particles mixed with glue to form a body of foam having a second density, wherein the second density is greater than the first density; cutting a portion of the body of foam to form a cushion having a first side, a second side, and a thickness; and adhering a fabric layer to the first side.

In a fourth independent aspect, the invention relates to a mat comprising: a cushion layer comprising a thickness, a top side, a bottom side, and wherein the top side is bonded to a fabric layer; wherein the cushion layer comprises a foam sheet having a foam sheet density; and wherein the foam sheet is comprised of a plurality of foam particles, wherein each of the foam particles has a first range of sizes and a first range of densities.

In a fifth independent aspect, the invention relates to a mat comprising: a cushion layer comprising a thickness, a top side, a bottom side, and wherein the top side is bonded to a fabric layer; wherein the cushion layer has a cushion layer density and comprises a plurality of foam particles bonded together; wherein the plurality of foam particles has an average particle density; and wherein the cushion layer density is greater than the second density.

In a sixth independent aspect, the invention relates to a method of forming a mat comprising: providing a mold; determining a desired volume of a cushion within the mold; providing a plurality of foam particles, wherein the foam particles in the plurality of foam particles have sizes in a range of between 2 mm and 4 mms; mixing the plurality of foam particles with a glue to form a glue-particle mixture; measuring a weight of the glue-particle mixture into the mold; and applying heat and compression to the glue-particle mixture.

### BRIEF DESCRIPTION OF THE FIGURES

With the intention of better showing the characteristics of the invention, herein after, as an example without any limitative character, some preferred embodiments are described, with reference to the accompanying drawings, wherein:

FIG. 1 represents a foam mat according to the inventions disclosed and taught herein;

FIG. 2 represents a cross-section according to line II-II in FIG. 1;

FIG. 3 represents one of many possible configurations for a mesh cloth;

FIG. 4 represents one of many possible configures for an antiskid layer; and

FIG. 5 represents a method according to the inventions which may be applied for manufacturing the foam mat of FIG. 1;

FIG. 6 represents a mold for making a foam mat;

FIG. 7 represents one embodiment of a cross-section according to line VII-VII in FIG. 6;

FIG. 8 represents another embodiment of a cross-section according to line VII-VII in FIG. 6.

### DETAILED DESCRIPTION

In many processes for making a cushion for a foam-based product, a large cylinder of virgin foam may be formed at a specific density. In this, the foam may be made from any type of polymer that is suitable for making a cushion. In a preferred embodiment, the foam may be made from foamed polyurethane. The cylinder of foam may then be axially sheared by a blade to remove specific thicknesses of foam that may then be used in making foam-based products. For example, the foam may be cut into pillows, cushions, mats, and other products. In making most of these products some of the edges may be cut away to provide a crisp, clean edge. The edge pieces have typically been discarded and/or used to make rebonded foam products, which are sometimes called rebond.

Lighter density edge pieces may not be suitable for making rebonded foam to be used as carpet padding. Lighter foam such as this may have a density in the range of 10 to 40 kilograms per cubic meter, with an average of between 20 and 30 kilograms per cubic meter. In this form, this foam is also not suitable for use in making mats, since the densities of foam used for mats is between 60 and 80 kilograms per cubic meter for bathmats, and between 100 and 160 kilograms per cubic meter for kitchen mats. Mats used for other applications, such as workstation mats, may extend across those ranges to be between 40 and 200 kilograms per cubic meter.

Applicant has invented methods to form this lighter density foam into a new foam product with configurable densities that may be used in many different applications. This disclosure exemplifies bath and kitchen mats as exemplary embodiments, however, those of ordinary skill in the art in possession of the teachings herein will recognize that the inventions disclosed herein may be applied in many other embodiments.

If virgin foam or discarded portions of virgin foam is to be used, it is first shredded into particles. Applicant has found that common shredding methods may be employed that will produce irregularly shaped particles. This means that upon examination, the particles may appear to be roughly spherical, but may have some irregularities from being truly spherical. Such irregularities may include surfaces that are flat and surfaces that have projections. Applicant has found that minor irregularities such as these may provide more surface area for bonding than would be provided with truly spherical particles.

10 In addition to shredding, which may also be called grinding, Applicant has found that cutting pieces of foam into cubes or cuboids may produce foam particles that may be used in the inventions disclosed and taught herein. Applicant expects that other shapes such as pyramids, prisms, and cylinders will also be acceptable shapes useful in the inventions disclosed and taught herein. However, since shredding may be 15 easier to accomplish, and provides acceptable results, the examples used within this specification will be, without limit, those of shredded foam of roughly spherical shapes.

Lighter density foam pieces that Applicant has used in the inventions disclosed and 20 taught herein have been of the density of between of 15 to 50 kilograms per cubic meter, with the majority of discarded foam having densities of between 20 and 30 kilograms per cubic meter. In the art, densities of foam are usually expressed where “kilograms per cubic meter” are described as “D”. Therefore, 30 D foam has a density of 30 kilograms per cubic meter. As will be apparent to those skilled in the art and in 25 possession of the inventions disclosed herein, other densities of foam may be used to produce foam articles of configurable densities for many uses.

Applicant has found that most people prefer a lower density foam for bathmats and a higher density foam for kitchen mats. Bathmats typically have a density of between about 60 D and 80 D, which is considered to be “soft”. Kitchen mats typically have a density of between about 100 D and 180 D, which is considered to be “hard”. Workstation mats may have densities of between 40 D and 200 D.

Additional envisioned embodiments include the use of particles of shredded rebonded foam. In most cases, rebonded foam has a density of from 95 D to over 100 D. In some embodiments, the rebond may have densities in the range of from 50 D to 250 D.

In the embodiment of making foam for bath and kitchen mats, shredding the foam should yield a range of particle sizes of between 1 mm (millimeter) and 15mms as they are measured across. If the particles were actually spheres, this would mean that the particles would have diameters of between 1 and 15mms. Several different methods may be employed to ensure that only particles of between 1 mm and 15 mms are used, Applicant has found satisfactory results using progressive sieves.

If particles in the full range of 1-15 mms are to be used, then a sieve having openings of 15 mms across may be used. This will allow particles having sizes of up to 15 mms across to pass through the sieve. Those of skill in the art will recognize that some particles smaller than 1 mm across will also pass through the sieve. In normal shredders, there are generally few of those and their inclusion in the rest of the process has not been found to present any difficulties. Those skilled in the art will also recognize that particles greater than 15 mm across may also pass through the sieve. This may happen if a particle is roughly ellipsoidal with a minor axis of 15 mms or less and a major axis of 15 mms or more, then it may go through the sieve along its minor axis. Applicants have found that having some particles of greater than 15 mms has not presented any difficulties in the processes and articles disclosed herein.

In this exemplary process, particles having a size greater than 15 mms may be gathered and sent back into the shredder so the resulting particles will have sizes less than 15 mms.

Some portions of the foam particles may be captured for specific use. For example, particles having a range of 1 mm to 8 mms may be captured as one portion, and particles having a range of 8 mms to 15 mms may be captured as a second portion. Those familiar with the art will understand that different sieves may be used to gather these portions.

Once a desirable portion of sized particles has been gathered, the particles may be mixed with glue and pressed together into a single body. While any shape may be utilized for the inventions disclosed and taught herein, Applicant has found that shaping the body into a cylinder may be beneficial to the process of utilizing the body of foam for making mats.

In a preferred embodiment, the particles may be pressed together in a mold to form a final product. As a non-limiting exemplary embodiment, a product may be made upside-down by placing a mat top surface in a mold. The mold may incline upwards at the edges thus making a trough with the mat top covering the surface of the trough such that the edges are raised above the level of the bottom of the trough. Once the top surface is placed into and covers the trough, it may be filled with the particles mixed with glue. That is to say that the fabric that will become the top of the mat may be placed into the trough such that it conforms to the shape of the trough and will still leave space that forms a trough. A bottom of the mat may be placed over the particles such that the edges of the bottom contact and overlap the edges of the top such that the particles are contained within. The mat may then be compressed such that the bottom of the mat is flat and the edges of the bottom are secured to the edges of the top with the form particles mixed with glue between. This will compress the particles between the bottom and the top.

In this preferred exemplary embodiment, a weight of particles may be placed in the trough which will have a known volume when the bottom is compressed against the top. In this way, the particles that are coated with the glue will have a known weight and volume and thus a configurable density.

The pressure may remain on the bottom of the mat until the glue sets. In this, heat may also be applied. The heat and pressure may be used to bond the edges of the bottom to the top and thus seal the particles into the space between them. Once the glue has set, the compressed and glued-together particles retain that shape and do not expand. That is to say that the foam between the top and the bottom of the mat does not expand by any substantial amount after being released from the mold.

In some embodiments where there is an overlap of the top fabric of the mat and the antiskid layer, a portion of the area of sealing between the top and bottom may be treated as flash and trimmed away from the finished product.

In an embodiment of making a roll by pressing the foam particles together with glue, a specific density may also be obtained. For example, a forming cylinder may be used to form the foam body. This cylinder may be closed at one end and have a lid that may tightly fit into the open end. A specific weight of the particles and glue mixture may be weighed into the cylinder and the lid pressed down upon the mixture until a specific volume is reached, thereby producing a body with a known density. Once the glue has set, the body may be released from the cylinder without changing its volume. That is to say that the foam body does not expand by any substantial amount after being released from the form.

Without wishing to be bound by any theories, it may be envisioned that the glue adhering the particles will maintain the compression of the particles in the shape and density of the mold after the glue sets or cures.

In one of many embodiments, high pressure and temperature may be used to set the glue and particles to a desired volume for a given weight of particles. In one of many embodiments that those of ordinary skill in the art may envision when in possession of the teachings and disclosures disclosed herein, the temperature of the foam particles and the glue may be at ambient room temperature when they are loaded into the cylinder. The cylinder and the contents may be kept at that temperature. In alternate embodiments, the glue may be a heat-settable glue and the temperature controlled in such a way as to set and/or cure the glue when in the cylinder. Similarly, a greater pressure may be applied to force the foam particles to compress while the glue is setting. In this way, once the glue has set, the foam particles may remain in a compressed state even after the formed body is removed from the forming cylinder.

While the entire range of foam particles may be used in manufacturing a body of foam, Applicant has found it to be advantageous to utilize the foam particles of a particular size to better form a body into a desired and configurable density. Applicant has found that using smaller particles, such as those between 1 mm and 8 mms, will respond to the pressure in the cylinder or within a form to make a higher density foam body, and larger particles, such as those between 8 mms and 15 mms will respond to the pressure in the cylinder to make a lower density foam body. That is to say that using particles of about between 1 and 8 mms may be used to make a foam body of between about 100 D and 220 D. On the other hand, using particles of about between 8 mms and 15 mms may be used to make a foam body of between about 40 D and 80 D. However, with an application of a sufficient amount of glue, compression, and heat, particles of about between 1 and 8 mms may be used to make lower density foam bodies, and particles of between 8 mms and 15 mms may be used to make higher density foam bodies.

While the examples of making bath and kitchen mats herein describe approximations of resulting densities, those of ordinary skill in the art and in possession of the inventions disclosed herein will be aware that the processes disclosed herein may be used to make very precise foam bodies. For example, a group of particles of foam of between 1 and 8 mms may be formed into a foam body of precisely any density between 100 D and 160 D with a small variance.

As disclosed and taught herein, this process will allow a consistent product to be made even with inconsistent pieces of foam being shredded to make the particles. That is to say that pieces of foam having a wide variety of densities may be shredded or cut into small particles and compressed with glue to make a foam having a specific and repeatable density.

In a preferred embodiment, an oil-based glue or adhesive may be used. This may be preferable to using latex or other water-based glues in the production of mats that are expected to be exposed to water in their use, such as bath and kitchen mats. However, in other embodiments, latex or other water-based glues may be used without departing from the scope of the inventions disclosed and taught herein.

A preferred glue may be a polyvinyl acetate (PVA) glue. Those of skill in the art will know of similar glues that may be used without departing from the scope of the claims of the inventions disclosed and taught herein.

The foam particles and the glue may be mixed before being loaded into the forming cylinder or mold, or they may be mixed while in the forming cylinder or mold. The intent of the mixing is to ensure that the foam particles are coated to a sufficient degree, so they adhere to adjacent foam particles. Before mixing, or even during mixing, additives such as antimicrobials, color additives, fire retardants, and/or any other additive known to those ordinarily skilled in the art, may be added to the mix.

The selection of a cylinder for the form of the body of foam allows it to be sheared into a long pad similar to the way that cylinders of virgin foam are sheared. That is to say that the cylinder may be axially rotated with a blade at a radial distance from the center and the blade advanced towards the center as the cylinder rotates. This may be used to produce a long sheet of foam of uniform thickness.

In another embodiment of the inventions taught and disclosed herein, sections of foam produced through the methods disclosed herein may be bonded together to form a mat. In this, slices of foam of approximate lengths of 10-50 mm, with cross-section areas of the foam strips of 1-50 mm² may be bonded together to form a mat.

This sheet of foam may be cut like any other sheet of foam to an appropriate size, such as for a bath or kitchen mat. A pile may be added to a top side. An additional fabric layer may be secured between the pile and the foam sheet as well if it is desired. On the bottom of the foam sheet, an antiskid mat may be secured. Similarly, a piece of fabric may be secured between the antiskid mat and the foam. Applicant has found that a piece of fabric bonded between the foam sheet and either or both of the pile and antiskid mat may form a better bond with the particles of the foam sheet and may prevent glue from seeping. For instance, in some loose piles the glue may rise up into the individual strands when pressed together with the foam. A layer of fabric will prevent that seepage, which may be uncomfortable to walk upon.

The washability of the produced mat is another of many aspects of the inventions disclosed and taught herein. Mats made from open cell foam have a desirable quality that they may be washed and dried in common household appliances such as a washer and dryer. Typical users have an expectation that mats may be dried in a dryer within a normal dryer run time, which is usually around an hour. Mats made with virgin open cell foams adhere to this expectation. However, mats made with closed cell foams usually take more than 1.5 to 2 hours in a common household dryer to dry.

Applicants have found that a mat made from the inventions disclosed and taught herein take on the characteristics of virgin open cell foam and may be dried in common household dryers in the same time as mats made with virgin open cell foam.

This does not preclude the use of closed cell foam in the manufacture of the foam as disclosed and taught herein. Applicant has found that some amounts of closed cell foam may be shredded as described herein and mixed with some amounts of open cell foam before being mixed with glue and pressed into a body. The resulting foam sheets maintain the characteristics of open cell foam in their softness/hardness, washability, and dryability.

Applicant has also found that the foam produced through the processes and methods disclosed herein are further recyclable. This foam may be utilized in making rebonded foam, or used again in the processes and methods disclosed and taught herein.

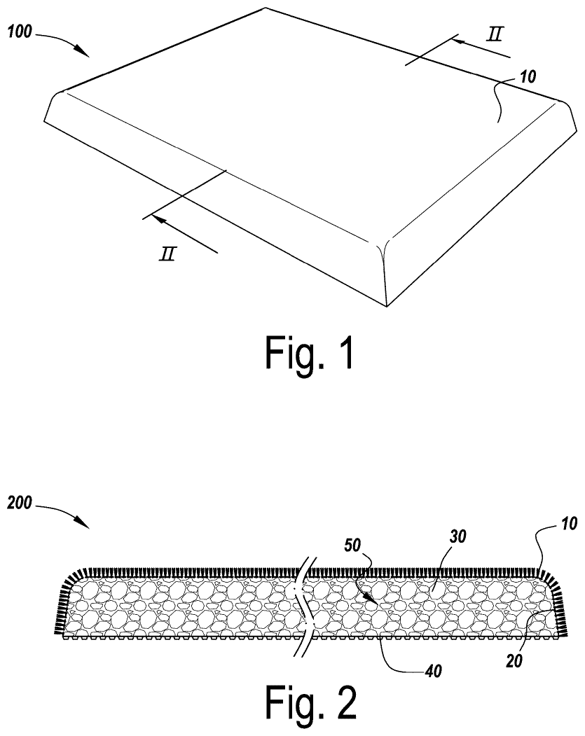

FIG. 1 represents a foam mat 100 according to the invention. A pile 10 may be seen to cover the top and sides of the mat 100. This pile 10 may be of any material suitable for use. For example, and without limitation, a bathmat may have a soft pile that may be more comfortable for bare feet, while a kitchen mat may have a short pile or a simple fabric that wears well for being stood upon with shoes.

FIG. 2 represents a cross-section 200 according to line II-II in FIG. 1. The pile 10 covers a fabric layer 20, which in turn covers a foam layer 50. Foam layer 50 sits upon an antiskid layer 40. The overall height of the foam layer 50 may be between 5 and 30 millimeters, which is typical for bath and kitchen mats.

It should be known that the fabric layer 20 is optional, and that another optional fabric layer (not shown in the figures) may be secured between the foam layer 50 and the antiskid layer 40.

Foam layer 50 is comprised of foam particles 30, which may be of a size of between 1 and 15 mms. In a first embodiment, they may be of a size of between 1 and 8 mms. In another embodiment, they may be of a size of between 8 and 15 mms. Other embodiments may use other size ranges.

An antiskid layer 40 may be secured to the bottom of the mat 100 using PVA glue,

PVC glue, a polyurethane (PU) glue, or any other suitable bonding substance. The antiskid layer 40 may be a single sheet, or it may have perforations or be made in the form of a mesh with open areas. Making the antiskid layer 40 in the form of a mesh reduces the overall weight of the foam mat 100. It may also provide more open spaces that may allow water and water vapor to exit the foam mat 100 while it is being dried.

The antiskid layer 40 may be made of polyester, styrene butadiene rubber (SBR), or any other material suitable for preventing the foam mat 100 from sliding on surfaces such as floors. In some cases, it may be preferable to have a mesh cloth bonded to the bottom of the foam mat 100, and then have an antiskid layer 40 bonded to the mesh cloth.

Similarly, the pile 10 and fabric layer 20 may be secured with PVC glue, PVA glue, PU glue, or any other suitable bonding substance. The pile 10 and fabric layer 20 may be secured to the foam layer 50 in such a way as to permit the flow of air into and out of the foam layer 50. This may further promote drying of the mat 100 in both ambient conditions and when in a dryer.

The foam particles 30 may be of the sizes and shapes disclosed herein and may be secured together in the manners disclosed herein. As disclosed these particles may be produced from foam sheets having densities of between 10 D and 50 D for the production of bath and kitchen mats, but may be made from foam of any density for other applications.

Applicant has found that pressing the foam particles 30 together as disclosed herein may still leave some interstitial gaps (not identified in this figure) between the foam particles 30. These interstitial voids may be regarded as flow passages between open cell foam particles that may further aid in allowing water and water vapor to be removed from the foam mat 100 by squeezing and/or drying.

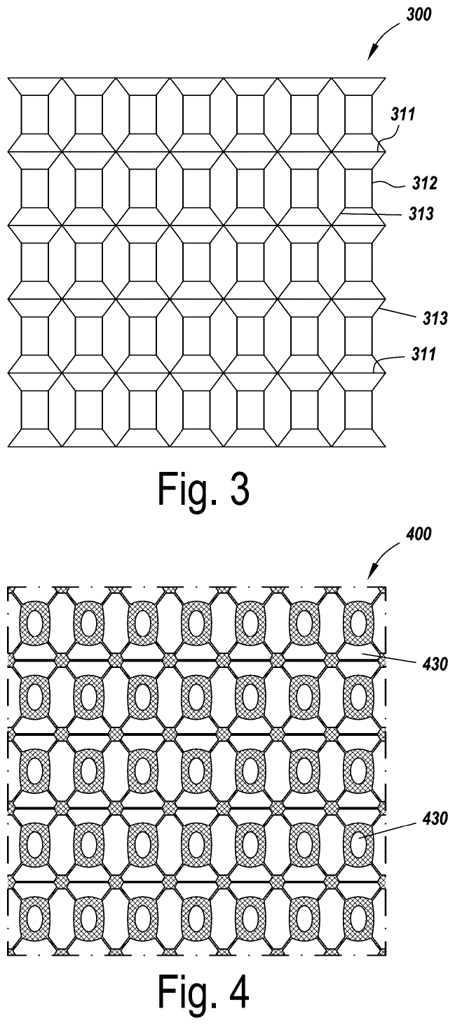

As shown in FIG. 3, a mesh cloth 300 of the anti-slip layer may include a plurality of parallel arranged warp lines 311, with a plurality of rectangular frame lines 312 distributed along the length direction of the warp line, and each edge corner of the rectangular frame line 312 and the warp line 311 may be connected by oblique lines 313. The spacing between the adjacent warp lines 311 may be between 10 mms and 15 mms, and the rectangular area of a single rectangular frame line 312 may be between 15 mm² and 50 mm². One of many beneficial effects of adopting this, or a similar format may be to improve the uniformity of the anti-slip layer distribution and improve the uniformity of the PVC or PVA hanging slurry on the mesh cloth 300 while adhering the antiskid layer 40 to the foam mat 100.

FIG. 4 represents one of many possible configures for an antiskid layer 400 that may be used in the inventions disclosed and taught herein. As may be seen by those of skill in the art and in possession of the inventions taught and disclosed herein, this antiskid layer 400 may be configured to be applied directly to the bottom of the foam mat 100, or over a mesh cloth 300. This exemplary antiskid layer 400 has openings 430 that may be configured to align with the openings of the mesh cloth 300.

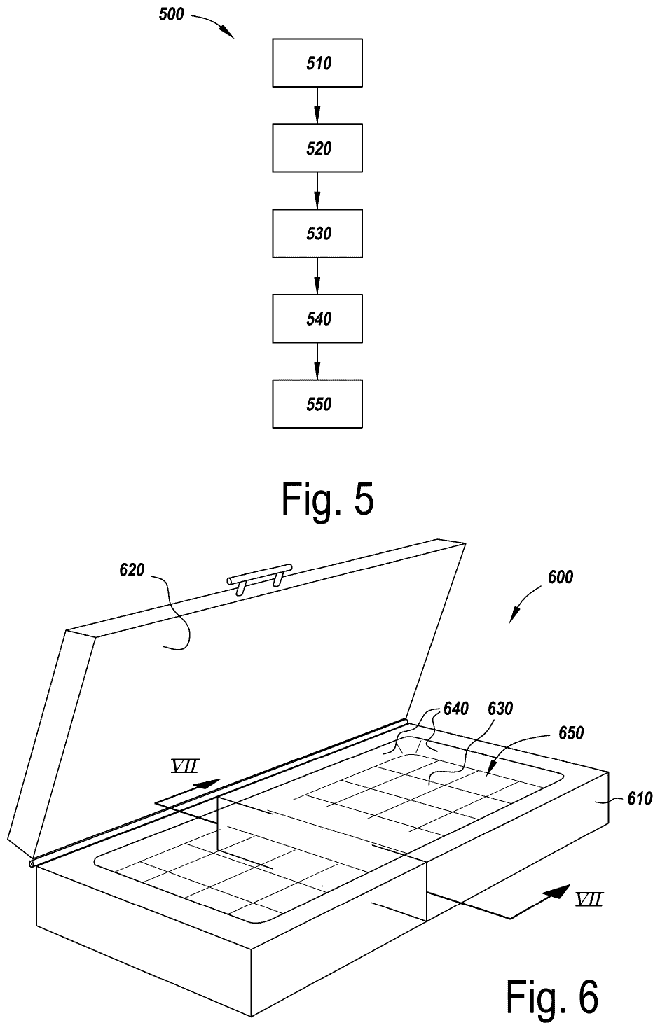

FIG. 5 represents one of many possible methods according to the inventions disclosed and taught herein, which may be applied for manufacturing the foam mat 100 of FIG. 1.

In a first step 510, segments of foam are gathered and milled to form a plurality of foam particles. The step of milling the foam may be of shredding, grinding, cutting, or otherwise manipulating the foam to produce particles. Generally, this step involves the operation of milling at least one segment of foam to form a plurality of foam particles. As disclosed herein, the densities of the foam pieces to be used may range from 10 D up to 50 D.

In the second step 520, the particles of foam are mixed with glue. The particles of foam may be all of the foam produced from the first step 510, or a subset of the particles that have a range of sizes. Generall, this step involves the operation of mixing the plurality of foam particles with glue. This step may be performed in a separate mixing chamber, or directly in a forming chamber or mold.

The third step 530 applies pressure and a temperature to the mixture of glue and foam particles within a form. One form may be a cylinder while another may be a box or a trough. In any container, a specific weight of the mixture of glue and particles is compressed to a specific volume to produce a foam body having a density. Generally, this step involves the operation of applying heat and compression to the plurality of foam particles mixed with glue to form a body of foam.

In an optional fourth step 540, the body of foam may be cut into shapes that may be used to produce mats or other articles. Generally, this step involves the operation of cutting a portion of the body of foam to form a cushion. This optional step 540 is not used in the embodiments where the particle-glue mixture is directly loaded into a mold.

In the fifth step 550, at least one fabric layer is adhered to the piece of foam to produce a mat. This fabric layer may be a pile. Additionally, an antiskid mat may be secured to the bottom of the mat. Generally, this step involves the operation of adhering a fabric layer to the top of the body of foam. In the embodiments were the particle-glue mixture is added into a mold, this step 550 may be performed while the particle-glue mixture is being added into the mold.

FIG. 6 illustrates a mold 600 that may be used in the formation of a mat as disclosed and taught herein. The mold 600 has a base 610 having a trough 650. The trough 650 is bounded by the sides 640 and a bottom 630. Above the base 610 is a mold top 620. The mold top 620 may be lowered onto the base 610 to enclose the trough 650.

The mold 600 may be heated by means known to those of skill in the art, and pressure may be applied to the mold top 620 so that the materials within the trough 650 are compressed when the mold top 620 is lowered to meet the base 610. In this process, the mold top 620 may be kept in place to provide continuous pressure to the mat as the glue applied to the particles sets.

Those of skill in the art will understand that the mold top 620 may be lowered onto the base 610 through any means known to those of skill in the art. For example, the illustrative embodiment of FIG. 6 shows that the mold top 620 may be hinged and raised and lowered by rotating it around the hinge. Those of skill in the art will understand that the mold top may also be raised and lowered through the use of a press where the mold top remains substantially above and parallel to the base 610.

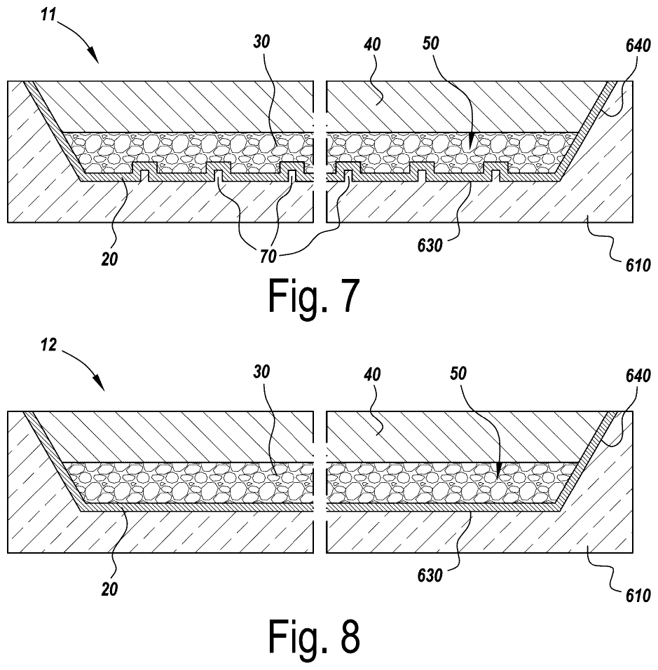

FIGS. 7 and 8 illustrate some embodiments of mats 11, 12 as they are being formed within the base 610. Those of skill in the art will be able to envision other embodiments that are still within the scope of the inventions taught, disclosed, and claimed herein.

In the first embodiment of FIG. 7, a fabric layer 20 has been laid into the trough 650 so that it contacts the sides 640 and bottom 630 of the base 610. Some amount of particles 30 mixed with glue may be placed into the trough 650 so that they contact the fabric layer 20. A specific weight of particles 30 mixed with glue may be loaded into the trough 650. The volume of the trough 650 less the thicknesses of the fabric layer 20 and the antiskid layer 40 will be known such that when the particles mixed with glue are compressed between the fabric layer 20 and the antiskid layer 40, a density of the particles mixed with glue will be achieved.

As has been disclosed herein, the particles may be made from shredding or grinding an assortment of foam trimmings. These may be from foam pieces having densities ranging from 10 D to 50 D. That is to say that all of the particles may come from a foam having a density of 15 D; all of the particles may come from a foam having a density of 40 D, or the particles may come from pieces of foam having densities anywhere between 10 D and 50 D. The original density of the foam is not consequential to making a product with a configurable density. The final density of the foam of the product will be determined by a weight of the particles as they are made into the mat and the volume of the space between the upper and lower layers of the mat.

In a preferred embodiment, the particles used in these exemplary mats 11, 12 may be ground to a size of between 2 mms and 4 mms, preferably to a size of between 2.5 mms and 3 mms. In a preferred embodiment, the glue mixed with the particles may be a polyvinyl acetate (PVA) glue. In a preferred embodiment, the final density of the mat 11, 12 may be between 140 D and 200 D, with a preference for a mat having a density of the interior foam of between 160 D and 180 D.

In a preferred embodiment the fabric layer 20 may be a polyester fabric with a weight of between 250 gsm (grams per square meter) and 300 gsm. In a more preferred embodiment, a weight of the polyester fabric layer 20 may be about 280 gsm.

In a preferred embodiment, the antiskid layer 40 may be made of styrene butadiene rubber (SBR). The SBR of the antiskid layer 40 may be bonded to the fabric layer 20 through chemical bonding, such as with an adhesive, through heat to mechanically bond the pieces, or through a combination of those.

FIG. 8 illustrates a mat 12 that has a flat fabric layer 20, while FIG. 7 illustrates a mat 11 that has design or functional indentations 70. The indentations 70 in the fabric layer 20 may be for a pleasing design or border, or it may be functional such that it allows the mat 11, 12 to be folded along an indentation 70.

In some embodiments, the indentations may be of a pattern. For example and without limitation, the mold top may be configured with a pattern such that a finished mat may have a bottom with indentations in the pattern of FIG. 3 or of FIG. 4.

As those of skill in the art and in possession of this disclosure and its teachings will understand, indentations may also be formed on the antiskid layer 40 for similar decorative and/or functional purposes.

The present invention is in no way limited to the herein above-described embodiments, on the contrary may such mats and methods be realized according to various variants, without leaving the scope of the present invention.

1-20. (canceled)

21. A mat comprising:
a cushion layer comprising a thickness, a top side, a bottom side, and wherein the top side is bonded to a fabric layer;
wherein the cushion layer comprises a foam sheet having a foam sheet density; and
wherein the foam sheet is comprised of a plurality of foam particles, wherein each of the foam particles has a first range of sizes and a first range of densities.

22. The mat of claim 21, further comprising an anti-skid layer bonded to the bottom side of the cushion layer.

23. The mat of claim 22, wherein the plurality of foam particles is comprised of milled recycled foam.

24. The mat of claim 23, wherein each of the particles of the plurality of foam particles is bonded together with glue.

25. The mat of claim 24, wherein the foam sheet density is between 40 and 200 kilograms per cubic meter.

26. The mat of claim 24, wherein the first range of sizes of the foam particles of the first plurality of foam particles is between 1 mm and 8 mms and the first density of the foam mat is between 100 and 160 kilograms per cubic meter.

27. The mat of claim 24, wherein the first range of the sizes of the foam particles of the first plurality of foam particles is between 2 mms and 4 mms and the first density of the foam mat is between 140 and 200 kg/cubic meter.

28. The mat of claim 24, wherein the first range of the sizes of the foam particles of the first plurality of foam particles is between 2.5 mms and 3 mms and the first density of the foam mat is between 160 and 180 kg/cubic meter.

29. The mat of claim 28, wherein the first range of densities of the foam particles of the first plurality of foam particles is between 10 and 50 kg/cubic meter.

30. A mat comprising:
a cushion layer comprising a thickness, a top side, a bottom side, and wherein the top side is bonded to a fabric layer;
wherein the cushion layer has a cushion layer density and comprises a plurality of foam particles bonded together;
wherein the plurality of foam particles has an average particle density; and
wherein the cushion layer density is greater than the average density.

31. The mat of claim 30, wherein the plurality of foam particles comprises open cell foam particles.

32. The mat of claim 31, wherein the cushion layer density is between 40 and 200 kilograms per cubic meter.

33. The mat of claim 32, wherein the particle density is between 10 and 50 kilograms per cubic meter.

34. The mat of claim 33, wherein the foam particles of the first plurality of foam particles are irregularly shaped and are between 1 mm and 15 mms.

35. The mat of claim 34, wherein the size of the foam particles of the first plurality of foam particles is between 2 mm and 4 mms and the cushion layer density of the foam mat is between 100 and 200 kg/cubic meter, and wherein the particle density is between 10 and 50kg/cubic meter.

36. The mat of claim 34, wherein the cushion layer comprises polyvinyl acetate glue.

37. A method of forming a mat comprising:
providing a mold;
determining a desired volume of a cushion within the mold;
providing a plurality of foam particles, wherein the foam particles in the plurality of foam particles have sizes in a range of between 2 mm and 4 mms;
mixing the plurality of foam particles with a glue to form a glue-particle mixture;
measuring a weight of the glue-particle mixture into the mold; and
applying heat and compression to the glue-particle mixture.

38. The method of forming the mat of claim 37, wherein a density of the cushion is determined before the step of measuring a weight of the glue-particle mixture into the mold.

39. The method of forming the mat of claim 38 comprising a step of providing a fabric layer and providing an antiskid layer; wherein the fabric layer comprises polyester, and the antiskid layer comprises styrene butadiene rubber.

40. The method of forming the mat of claim 39, wherein the mold comprises indentations.
